(19) United States
(12) Patent Application Publication
(10) Pub. No.: US 2024/0007163 A1
(43) Pub. Date: Jan. 4, 2024

(54) CHANNEL STATE INFORMATION REFERENCE SIGNAL RESOURCES AND REPORTING BASED ON ANTENNA GROUPING

(71) Applicant: QUALCOMM Incorporated, San Diego, CA (US)

(72) Inventors: Ahmed ELSHAFIE, San Diego, CA (US); Runxin WANG, San Diego, CA (US); Muhammad Sayed Khairy ABDELGHAFFAR, San Jose, CA (US); Yu ZHANG, San Diego, CA (US); Hwan Joon KWON, San Diego, CA (US); Krishna Kiran MUKKAVILLI, San Diego, CA (US); Tingfang JI, San Diego, CA (US)

(21) Appl. No.: 18/253,193

(22) PCT Filed: Jan. 29, 2021
(86) PCT No.: PCT/CN2021/074467

§ 371 Date: May 16, 2023

(51) Int. Cl. H04B 7/06; H04B 7/0404

(52) U.S. Cl. CPC H04B 7/0626; H04B 7/0404; H04B 7/061

(57) ABSTRACT

Methods, systems, and devices for wireless communications are described. The described techniques provide for a base station using antenna groups configured at a user equipment (UE) for CSI reporting. The base station may transmit an indication of the antenna group that the UE is to use for measuring and reporting CSI. Based on the received indication, the UE may measure a reference signal transmitted by the base station and received at the UE using one or more antennas of the antenna group in accordance with the indication. The UE may transmit, to the base station, a CSI report that is based on the measuring of the reference signal using the one or more antennas of the antenna group.

### CROSS REFERENCE

The present Application is a 371 national stage filing of International PCT Application No. PCT/CN2021/074467 by ELSHAFIE et al. entitled “CHANNEL STATE INFORMATION REFERENCE SIGNAL RESOURCES AND REPORTING BASED ON ANTENNA GROUPING,” filed Jan. 29, 2021, which is assigned to the assignee hereof, and which is expressly incorporated by reference in its entirety herein.

### FIELD OF TECHNOLOGY

The following relates to wireless communications, including channel state information reference signal (CSI-RS) resources and reporting based on antenna grouping.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

A base station may request that a UE transmit a set of sounding reference signals (SRSs) in order to estimate a channel and to determine the appropriate precoding to use for a data transmission. In order to conserve resources (e.g., time and power resources) the UE and/or the base station may determine to use antenna groups for SRS transmissions. Correlated antennas may be grouped in order to reduce power and timing resources for SRS transmissions.

### SUMMARY

The described techniques relate to improved methods, systems, devices, and apparatuses that support channel state information reference signal (CSI-RS) resources and reporting based on antenna grouping. Generally, the described techniques provide for a base station using antenna groups configured at a user equipment (UE) for CSI reporting. The base station may transmit an indication of the antenna group that the UE is to use for measuring and reporting for CSI. The UE may measure a reference signal transmitted by the base station and received at the UE using one or more antennas of the antenna group in accordance with the indication. The UE may transmit, to the base station, a CSI report that is based on the measuring of the reference signal using the one or more antennas of the antenna group.

A method for wireless communications at a user equipment (UE) is described. The method may include receiving, from a base station, an indication of an antenna group that the UE is to use in measuring and reporting channel state information, the antenna group being one of a set of multiple antenna groups configured at the UE, measuring a reference signal transmitted by the base station and received at the UE using one or more antennas of the antenna group in accordance with the indication, and transmitting, to the base station, a channel state information report that is based on the measuring of the reference signal using the one or more antennas of the antenna group.

An apparatus for wireless communications at a UE is described. The apparatus may include a processor, memory in electronic communication with the processor, and instructions stored in the memory. The instructions may be executable by the processor to cause the apparatus to receive, from a base station, an indication of an antenna group that the UE is to use in measuring and reporting channel state information, the antenna group being one of a set of multiple antenna groups configured at the UE, measure a reference signal transmitted by the base station and received at the UE using one or more antennas of the antenna group in accordance with the indication, and transmit, to the base station, a channel state information report that is based on the measuring of the reference signal using the one or more antennas of the antenna group.

Another apparatus for wireless communications at a UE is described. The apparatus may include means for receiving, from a base station, an indication of an antenna group that the UE is to use in measuring and reporting channel state information, the antenna group being one of a set of multiple antenna groups configured at the UE, means for measuring a reference signal transmitted by the base station and received at the UE using one or more antennas of the antenna group in accordance with the indication, and means for transmitting, to the base station, a channel state information report that is based on the measuring of the reference signal using the one or more antennas of the antenna group.

A non-transitory computer-readable medium storing code for wireless communications at a UE is described. The code may include instructions executable by a processor to receive, from a base station, an indication of an antenna group that the UE is to use in measuring and reporting channel state information, the antenna group being one of a set of multiple antenna groups configured at the UE, measure a reference signal transmitted by the base station and received at the UE using one or more antennas of the antenna group in accordance with the indication, and transmit, to the base station, a channel state information report that is based on the measuring of the reference signal using the one or more antennas of the antenna group.

Some examples of the method, apparatuses, and non-transitory computer-readable medium described herein may further include operations, features, means, or instructions for transmitting, to the base station, a respective sounding reference signal using at least one antenna of each antenna group of the set of multiple antenna groups, where the indication may be received based on transmitting the respective sounding reference signal for each antenna group.

Some examples of the method, apparatuses, and non-transitory computer-readable medium described herein may further include operations, features, means, or instructions for determining a precoding for the reference signal in accordance with a precoding that may be used to transmit the respective sounding reference signal from the indicated antenna group.

In some examples of the method, apparatuses, and non-transitory computer-readable medium described herein, receiving the indication may include operations, features, means, or instructions for receiving, from the base station, a channel state information report configuration with the indication of the antenna group.

Some examples of the method, apparatuses, and non-transitory computer-readable medium described herein may further include operations, features, means, or instructions for determining one or more reference signal resources to use for measuring the reference signal based on the channel state information report configuration and generating the channel state information report in accordance with the channel state information report configuration and that may be based on the measuring of the reference signal using the one or more antennas and the one or more reference signal resources.

In some examples of the method, apparatuses, and non-transitory computer-readable medium described herein, receiving the indication may include operations, features, means, or instructions for receiving, from the base station an indication of a channel state information trigger state and determining the antenna group based on a mapping of the antenna group to one or more channel state information report configurations for the indication of the channel state information trigger state.

In some examples of the method, apparatuses, and non-transitory computer-readable medium described herein, receiving the indication of the channel state information trigger state may include operations, features, means, or instructions for receiving a downlink control information message, a medium access control layer control element message, or a combination thereof.

Some examples of the method, apparatuses, and non-transitory computer-readable medium described herein may further include operations, features, means, or instructions for receiving, from the base station, a first control message that maps a respective antenna group of the set of multiple antenna groups to each trigger state of a set of trigger states, where the indication may be received based at least in part receiving an indication of a trigger state of the set of trigger states.

In some examples of the method, apparatuses, and non-transitory computer-readable medium described herein, receiving the first control message may include operations, features, means, or instructions for receiving a radio resource control message, a medium access control layer control element message, or a combination thereof.

Some examples of the method, apparatuses, and non-transitory computer-readable medium described herein may further include operations, features, means, or instructions for receiving, from the base station, a first control message that maps one or more antenna groups of the set of multiple antenna groups to a respective antenna group index of a set of antenna group indexes, where the indication of the antenna group may be received based on receiving an indication of an antenna group index of the set of antenna group indexes.

In some examples of the method, apparatuses, and non-transitory computer-readable medium described herein, receiving the first control message may include operations, features, means, or instructions for receiving a radio resource control message, a medium access control layer control element message, or a combination thereof.

In some examples of the method, apparatuses, and non-transitory computer-readable medium described herein, receiving the indication may include operations, features, means, or instructions for receiving an indication of a trigger state of a set of trigger states and an indication of the antenna group index of the set of antenna group indexes, where the antenna group corresponding to the antenna group index may be used for at least one channel state information report configuration corresponding to the trigger state.

Some examples of the method, apparatuses, and non-transitory computer-readable medium described herein may further include operations, features, means, or instructions for transmitting, to the base station, an indication that the UE may be capable of supporting the set of multiple antenna groups, where the indication of the antenna group may be received based on transmitting the indication that the UE may be capable of supporting the set of multiple antenna groups.

In some examples of the method, apparatuses, and non-transitory computer-readable medium described herein, each antenna group of the set of multiple antenna groups includes a same number of antennas or each antenna.

In some examples of the method, apparatuses, and non-transitory computer-readable medium described herein, a first antenna group of the set of multiple antenna groups includes a first quantity of antennas that may be different from a second quantity of antennas of a second antenna group of the set of multiple antenna groups.

A method for wireless communications at a base station is described. The method may include determining that a UE is configured with a set of multiple antenna groups, transmitting, to the UE, an indication of an antenna group of the set of multiple antenna groups that the UE is to use in measuring and reporting channel state information to the base station, transmitting a reference signal to the UE, receiving, from the UE, a channel state information report that is based on measurements made by the UE of the reference signal using one or more antennas of the antenna group, and communicating, with the UE, based on the channel state information report.

An apparatus for wireless communications at a base station is described. The apparatus may include a processor, memory in electronic communication with the processor, and instructions stored in the memory. The instructions may be executable by the processor to cause the apparatus to determine that a UE is configured with a set of multiple antenna groups, transmit, to the UE, an indication of an antenna group of the set of multiple antenna groups that the UE is to use in measuring and reporting channel state information to the base station, transmit a reference signal to the UE, receive, from the UE, a channel state information report that is based on measurements made by the UE of the reference signal using one or more antennas of the antenna group, and communicate, with the UE, based on the channel state information report.

Another apparatus for wireless communications at a base station is described. The apparatus may include means for determining that a UE is configured with a set of multiple antenna groups, means for transmitting, to the UE, an indication of an antenna group of the set of multiple antenna groups that the UE is to use in measuring and reporting channel state information to the base station, means for transmitting a reference signal to the UE, means for receiving, from the UE, a channel state information report that is based on measurements made by the UE of the reference signal using one or more antennas of the antenna group, and means for communicating, with the UE, based on the channel state information report.

A non-transitory computer-readable medium storing code for wireless communications at a base station is described. The code may include instructions executable by a processor to determine that a UE is configured with a set of multiple antenna groups, transmit, to the UE, an indication of an antenna group of the set of multiple antenna groups that the UE is to use in measuring and reporting channel state information to the base station, transmit a reference signal to the UE, receive, from the UE, a channel state information report that is based on measurements made by the UE of the reference signal using one or more antennas of the antenna group, and communicate, with the UE, based on the channel state information report.

Some examples of the method, apparatuses, and non-transitory computer-readable medium described herein may further include operations, features, means, or instructions for receiving, from the UE, a respective sounding reference signal using at least one antenna of each antenna group of the set of multiple antenna groups, where the indication may be transmitted based on receiving the respective sounding reference signal for each antenna group.

In some examples of the method, apparatuses, and non-transitory computer-readable medium described herein, transmitting the indication may include operations, features, means, or instructions for transmitting, to the UE, a channel state information report configuration with the indication of the antenna group.

Some examples of the method, apparatuses, and non-transitory computer-readable medium described herein may further include operations, features, means, or instructions for determining one or more reference signal resources that the UE may be to use for measuring the reference signal based on the channel state information report configuration, where the received channel state information report indicates the measurements corresponding to the one or more reference signal resources.

In some examples of the method, apparatuses, and non-transitory computer-readable medium described herein, transmitting the indication may include operations, features, means, or instructions for transmitting, to the UE, an indication of a channel state information trigger state, where the indication of the antenna group may be transmitted based on the antenna group being mapped to the indicated channel state information trigger state.

In some examples of the method, apparatuses, and non-transitory computer-readable medium described herein, transmitting the indication of the channel state information trigger state may include operations, features, means, or instructions for transmitting a downlink control information message, a medium access control layer control element message, or a combination thereof.

Some examples of the method, apparatuses, and non-transitory computer-readable medium described herein may further include operations, features, means, or instructions for transmitting, to the UE, a first control message that maps a respective antenna group of the set of multiple antenna groups to each trigger state of a set of trigger states, where the indication may be transmitted based on transmitting an indication of a trigger state of the set of trigger states.

In some examples of the method, apparatuses, and non-transitory computer-readable medium described herein, transmitting the first control message may include operations, features, means, or instructions for transmitting a radio resource control message, a medium access control layer control element message, or a combination thereof.

Some examples of the method, apparatuses, and non-transitory computer-readable medium described herein may further include operations, features, means, or instructions for transmitting, to the UE, a first control message that maps one or more antenna groups of the set of multiple antenna groups to a respective antenna group index of a set of antenna group indexes, where the indication of the antenna group may be transmitted based on transmitting an indication of an antenna group index of the set of antenna group indexes.

In some examples of the method, apparatuses, and non-transitory computer-readable medium described herein, transmitting the first control message may include operations, features, means, or instructions for transmitting a radio resource control message, a medium access control layer control element message, or a combination thereof.

In some examples of the method, apparatuses, and non-transitory computer-readable medium described herein, transmitting the indication may include operations, features, means, or instructions for transmitting an indication of a trigger state of a set of trigger states and an indication of the antenna group index of the set of antenna group indexes, where the antenna group corresponding to the antenna group index may be used for at least one channel state information report configuration corresponding to the trigger state.

Some examples of the method, apparatuses, and non-transitory computer-readable medium described herein may further include operations, features, means, or instructions for receiving, from the UE, an indication that the UE may be capable of supporting the set of multiple antenna groups, where the indication of the antenna group may be transmitted based on transmitting the indication that the UE may be capable of supporting the set of multiple antenna groups.

### BRIEF DESCRIPTION OF THE DRAWINGS

FIG. 1 illustrates an example of a wireless communications system that supports channel state information reference signal (CSI-RS) resources and reporting based on antenna grouping in accordance with aspects of the present disclosure.

FIG. 2 illustrates an example of a wireless communications system that supports CSI-RS resources and reporting based on antenna grouping in accordance with aspects of the present disclosure.

FIG. 3 illustrates an example of a resource configuration that supports CSI-RS resources and reporting based on antenna grouping in accordance with aspects of the present disclosure.

FIG. 4 illustrates an example of a set of trigger states that supports CSI-RS resources and reporting based on antenna grouping in accordance with aspects of the present disclosure.

FIG. 5 illustrates an example of a process flow that illustrates CSI-RS resources and reporting based on antenna grouping in accordance with aspects of the present disclosure.

FIGS. 6 and 7 show block diagrams of devices that support CSI-RS resources and reporting based on antenna grouping in accordance with aspects of the present disclosure.

FIG. 8 shows a block diagram of a communications manager that supports CSI-RS resources and reporting based on antenna grouping in accordance with aspects of the present disclosure.

FIG. 9 shows a diagram of a system including a device that supports CSI-RS resources and reporting based on antenna grouping in accordance with aspects of the present disclosure.

FIGS. 10 and 11 show block diagrams of devices that support CSI-RS resources and reporting based on antenna grouping in accordance with aspects of the present disclosure.

FIG. 12 shows a block diagram of a communications manager that supports CSI-RS resources and reporting based on antenna grouping in accordance with aspects of the present disclosure.

FIG. 13 shows a diagram of a system including a device that supports CSI-RS resources and reporting based on antenna grouping in accordance with aspects of the present disclosure.

FIGS. 14 through 18 show flowcharts illustrating methods that support CSI-RS resources and reporting based on antenna grouping in accordance with aspects of the present disclosure.

### DETAILED DESCRIPTION

A base station may request that a user equipment (UE) transmit a set of sounding reference signals (SRSs) in order to estimate a channel and to determine the appropriate precoding to use for a data transmission. In order to conserve resources (e.g., time and power resources) the UE and/or the base station may determine to use antenna groups for SRS transmissions by the UE. That is, some antennas may be correlated, and as such, the base station may use one or more SRSs transmitted using one or more first antennas of a UE to estimate channels corresponding to one or more second, correlated antennas. Thus, these correlated antennas may be grouped in order to reduce power and timing resources for SRS transmissions.

Channel state information (CSI) reports may be used to determine various channel characteristics. For example, a base station may transmit reference signals, and the UE may generate a report based on measurements of the reference signals. The UE may be configured with various CSI report configurations using control signaling, such as radio resource control (RRC), medium access control control-element (MAC-CE), and/or downlink control information (DCI) messaging. Based on the configurations, the UE may utilize various resources for measuring and reporting CSI. A wireless communications system may benefit from leveraging SRS antenna groups, or other antenna groups, for CSI reporting.

Techniques described herein support using antenna groups (e.g., configured for SRS transmission) for CSI reporting. For example, a base station may receive an SRS, estimate the channel, and may seek additional information for estimating the channel or determining the channel quality. According to the techniques herein, the base station may indicate that the UE is to use one or more of the SRS antenna groups to measure a reference signal (e.g., a CSI-RS). The UE may use the antenna group to receive and measure the reference signal and use the measurements to generate the CSI report. The indication of the antenna group may be in the form of a DCI message that includes an index that corresponds to the antenna group. In other examples, the indication may be based on a trigger state indicated by RRC, MAC-CE, and/or DCI. That is, the RRC messaging may be used to map one or more SRS groups to a set of trigger states. MAC-CE messaging may be used to down-select the trigger states, and DCI messaging may be used to indicate one or more trigger states from the down-selected states. The UE may determine the SRS group based on the DCI indicated trigger state. In another example, RRC messaging may be used to map one or more antenna groups to an index, and the base station may signal the index via a CSI report configuration, trigger state, DCI, etc.

Aspects of the disclosure are initially described in the context of wireless communications systems. Aspects of the disclosure are further described with respect to a wireless communications system illustrating CSI reporting based on antenna groupings, resource configurations, CSI reporting configurations, and a process flow diagram. Aspects of the disclosure are further illustrated by and described with reference to apparatus diagrams, system diagrams, and flowcharts that relate to CSI-RS resources and reporting based on antenna grouping.

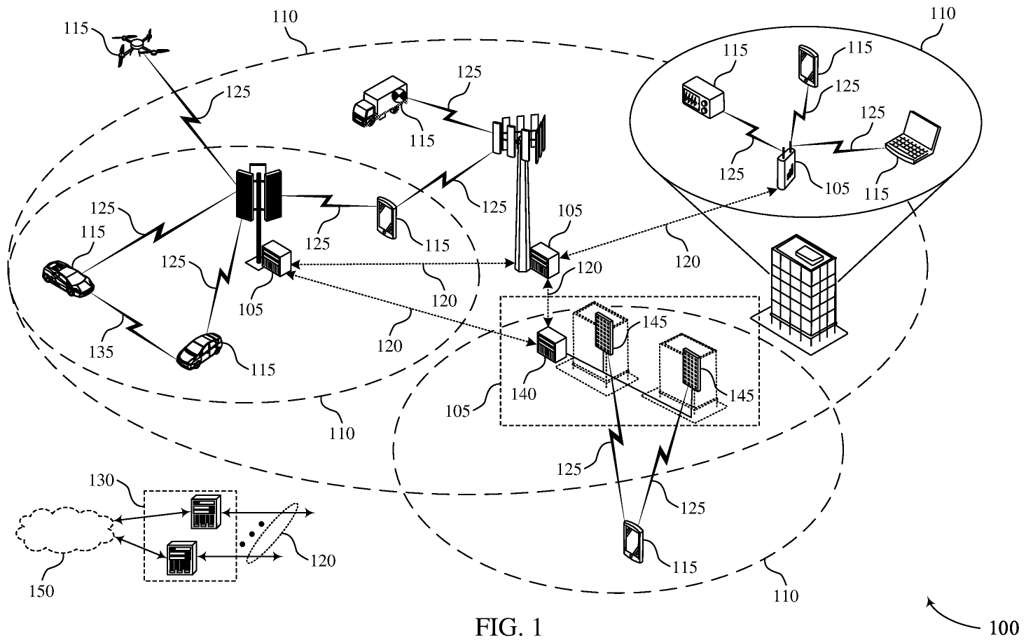

FIG. 1 illustrates an example of a wireless communications system 100 that supports CSI-RS resources and reporting based on antenna grouping in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of T, =1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

The wireless communications system 100 may support MIMO communications. To support the MIMO communications, a base station 105 and a UE 115 may coordinate to identify precoding (e.g., beamforming configurations) to use for uplink communications. The precoding determinations may be based on measurements of one or more SRS transmitted via SRS resources by a UE 115. Thus, the base station may request that the UE 115 send a set of SRS in order to estimate channels. In some cases, the base station 105 and the UE 115 may utilize codebook-based precoding determination. That is, the base station 105 may include an indication in an uplink grant of the precoding that the UE 115 is to use for uplink communications based on measurements of one or more SRS transmissions by the UE 115. In some examples, the base station 105 and the UE 115 may utilize non-codebook-based precoding. For example, the UE 115 may transmit one or more SRSs over one or more SRS resources. The base station 105 may measure the SRS reference signals and indicate a subset of the SRS resources that the UE 115 is to use for an uplink communication. In some cases, antennas at the UE 115 may be correlated, meaning that the base station 105 may measure a reference signal transmitted via a first antenna of the UE 115 to estimate characteristics (e.g., channel characteristics) of one or more other antennas at the UE 115. Thus, in order to conserve resources (e.g., time and power resources) the UE 115 and/or the base station 105 may determine to use antenna groups for SRS transmissions.

As described herein, the wireless communications system 100 may also support CSI reports that may be used by a base station 105, a UE 115, or other components of the wireless communications system 100 to determine various channel characteristics. For example, a base station 105 may transmit reference signals, and the UE 115 may generate a report based on measurements of the reference signals. The UE 115 may be configured with various CSI report configurations via control messaging by the base station 105.

Techniques described herein support leveraging antenna groups, such as antenna groups configured for SRS transmission, for CSI reporting. For example, a base station 105 may receive SRSs transmitted by a UE 115 and estimate the channel based on a measurement of the SRSs. In order to identify additional channel characteristics, the base station 105 may instruct the UE 115 to use one of the antenna groups to receive and measure the reference signal. In some examples, an antenna group may be indicated by the base station 105 via a partial SRS resource identifier, where the SRS partial resource identifier corresponds to an antenna group (associated with an SRS resource) configured during SRS configuration. During SRS configuration, each SRS resource may be associated with a group index and used to sound a group of antennas. In other examples, the antenna group may be signaled via an index that is configured by the UE 115 and/or the base station 105 separate from the SRS configuration. The UE 115 may receive and measure the reference signal using the indicated group of antennas and generate a CSI report based on the reference signal measurements. The UE 115 may transmit the CSI report to the base station 105. The base station 105 may use the report to determine additional characteristics for a channel associated with the antenna group. In some cases, the base station may map the antenna groups to respective antenna group indexes, CSI-RS trigger states, and/or CSI report configurations. Thus, the base station 105 may indicate the group to use for CSI measurement/reporting using an indication of an index, a CSI-RS trigger state, or a CSI report configuration. These and other implementations are further described with respect to the following figures.

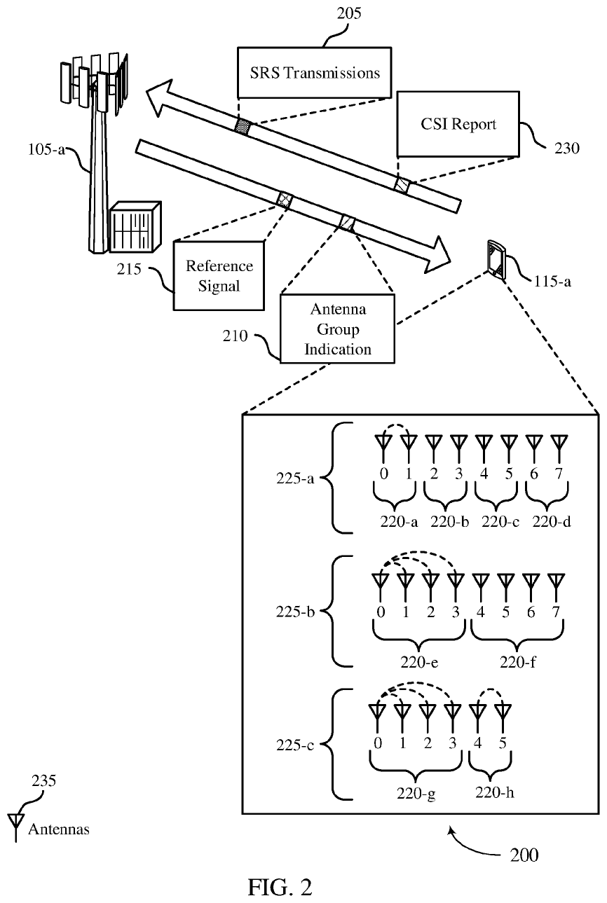

FIG. 2 illustrates an example of a wireless communications system 200 that supports CSI-RS resources and reporting based on antenna grouping in accordance with aspects of the present disclosure. In some cases, the wireless communications system 200 illustrates or includes aspects of wireless communications system 100. The wireless communications system 200 includes a base station 105-a and a UE 115-a, which may be examples of the corresponding devices of FIG. 1. Specifically, FIG. 2 illustrates example communications between the base station 105-a and the UE 115-a. In order to support MIMO communications, the UE 115-a may be configured with multiple antennas 235, which may be examples of transmission (Tx) antennas, reception (Rx) antennas, or both. In some examples, an antenna 235 or set of antennas 235 (e.g., an antenna array) can function as both reception and transmission antennas simultaneously or may switch between reception and transmission during intervals.

In order to support communications, the UE 115-a may be configured to transmit a set of SRSs in an SRS transmission 205. Each SRS may correspond one or more SRS resources, one or more antennas/antenna ports, or a combination thereof. The base station 105-a may measure received SRSs to determine an appropriate precoding that the UE 115-a is to use for subsequent uplink communications. The inclusion of multiple antennas 235 at the UE 115-a may lead to additional time/power resources for communications, such as SRS transmissions 205. In some cases, a UE 115-a with multiple (e.g., six or eight) antennas may not sound all the antennas due to large insertion loss. Further, some fixed relationships or correlations may exist between different groups of antennas, and information may be reported or determined for a particular antenna 235 without transmission of an SRS from that antenna 235.

Thus, in order to leverage the correlations between antennas and to conserve power/time resources, antennas may be configured into one or more groups 220 for SRS transmissions 205. Each antenna within antenna group 220 may be cross correlated, meaning that the base station 105-a may determine some information corresponding to the channel for each antenna within the group based on transmissions by a subset of the antennas within the group. For example, antennas 235 of antenna group 220-a may be cross correlated, and as such, the base station 105-a may determine channel characteristics for antenna 1 of antenna group 220-a based on transmission of an SRS by antenna 0 in antenna group 220-a. Similarly, antennas 235 of antenna group 220-e may be cross correlated, and as such, the base station 105-a may determine channel characteristics of antennas 1, 2, and 3 of antenna group 220-e based on transmission of antenna 0 in antenna group 220-e. In some cases, the UE 115-a may include correlation information in an uplink transmission (e.g., SRS transmission 205) such that the base station may derive the channel characteristics for the unsounded antennas 235. This process may be referred to as UE-assisted channel reconstruction based on partial spatial sounding. The UE 115-a may be preconfigured with the correlation information, the UE 115-a may determine such information using a process with a base station 105, or some combination thereof. Thus, to support partial spatial sounding, the UE 115-a may divide the antennas 235 into groups and sound one or more antennas 235 from each group (e.g., transmit an SRS transmission 205). The UE 115-a may also report the correlation information among the antennas within the same group. The base station 105-a may perform interpolation/extrapolation based on the correlation information and uplink sounding transmission to determine a channel matrix.

In some cases, the UE 115-a may indicate an antenna grouping (e.g., SRS grouping) capability to the base station 105-a. This indication may be transmitted in conjunction with a beam switching capability. In some examples, this reporting may be transmitted via control signaling, such as radio resource control (RRC) signaling. As illustrated in antenna configurations 225-a and 225-b, the antenna groupings may be uniform, meaning that each antenna group 220 includes a same number of antennas 235. As illustrated in antenna configuration 225-c, the antenna groupings may be non-uniform.

The UE 115-a and/or the base station 105-a may use a notation to indicate antenna grouping information. The notation may be in the form: xTyGzR, where x corresponds to the number of transmission antennas for each SRS, y corresponds to the number of groups/antenna ports, z corresponds to the number of reception (Rx), and xTyGzR corresponds to xTyzR SRS switching. For example, for antenna configuration 225-a, the UE 115-a may signal xT4GR (xT8R), for antenna configuration 225-b, the UE 115-a may signal xT2G4R (xT8R), and for antenna configuration 225-c, the UE 115-a may signal xT2G (xT6R).

As described herein, the base station 105-a and the UE 115-a may use CSI reference signals, resources, and reporting for determining channel characteristics. A set of resources that are to be used for receiving reference signals may be indicated via a CSI report configuration. The CSI report configuration may include an indication of a non-zero power (NZP) CSI-RS resource setting for channel measurement (CMR). Further, zero, one, or two resources may be indicated for interference measurement (IMR). If there is one setting for IMR, the resource may be for either CSI interference measurement (CSI-IM) with a zero-power setting or for a NZP-CSI-RS setting. If two IMRs are configured, then one of the resources may be used for the CSI-IM setting and one of the resources may be used for the NZP CSI-RS setting. For NZP-CSI-RS IMR, a single port in the activated resources may be assumed as an interference layer. In such cases, the UE 115-a may aggregate each of the interference layers in the CSI calculation. Further, there may be a resources-wise association between CMR and CSI-IM.

In some cases, the CSI reporting may be triggered aperiodically. Thus, a combination of RRC, MAC-CE, and DCI signaling may be used to trigger CSI reporting. For example, RRC signaling may be used to configure a quantity of trigger states per serving cell (e.g., 128). Each trigger state may include one or more CSI report configurations. Further, for each trigger state, RRC signaling may be used to activate one resource set from multiple available resource sets for each CSI report configuration in a trigger state. After RRC configuration of the trigger states, MAC-CE messaging may be used to down-select trigger states. For example, a MAC-CE message may downselect 64 trigger states from 128 states. Thereafter, DCI signaling may be used to activate one trigger state from the 64 (or otherwise remaining) trigger states. For example, the DCI may include a field (e.g., 6-bit field) that indicates a trigger state. The field may be included in an uplink related DCI, such as DCI format 0_1 or 0_2.

According to techniques described herein, after receiving the indication of an SRS grouping capability, or receiving the SRS transmissions 205, the base station 105-a may determine additional information for one or more channels associated with an antenna group using CSI reporting. For example, the base station 105-a may determine to identify additional information for a channel associated with antenna group 220-a. The base station 105-a may transmit an antenna group indication 210, which indicates the antenna group 220-a. Based on the antenna group indication 210, the UE 115-a may be configured to receive and measure a reference signal 215 (e.g., CSI-RS), transmitted by the base station 105-a, using the indicated antenna group 220-a. The UE 115-a may generate a CSI report 230 based on the measurement and transmit the CSI report 230 to the base station 105-a. The base station 105-a may then determine additional characteristics for the channel associated with antenna group 220-a based on the CSI report 230. As such, one or more CSI-RS resources that are used for CSI reporting and measuring may be based on the partial or fully sounded reception antennas. In some examples, the base station 105-a may dynamically change or modify the antenna groups that are to be used for CSI measurement and reporting.

The base station 105-a may indicate (e.g., antenna group indication 210) the antenna group 220 using various techniques. According to a first technique, the base station 105-a may indicate which antenna group 220 that the UE 115-a is to use for both the CSI-RS reception and the corresponding report 230 using a CSI report configuration indication. For example, the base station 105-a indicate the antenna group 220 with an indication of the CSI report configuration. In some cases, the base station 105-a may use control signaling (e.g., RRC, MAC-CE, DCI signaling) to map a set of antenna groups (e.g., SRS resources) to a set of CSI-Report configurations. In such cases, the antenna group indication 210 may be based on an indicated CSI report configuration. In yet another example, the antenna groups 220 (e.g., SRS resources) may be mapped to a set of indexes using control signaling, and the index may be indicated with the indication or via an indication of the CSI report configuration (e.g., the indexes are mapped to various CSI report configurations via control signaling).

According to another technique, control signaling (e.g., RRC) may map each SRS partial resource identifier (e.g., antenna group 220) to each trigger state of a set of trigger states. As such, when the UE 115-a receives an indication of a trigger state to use for CSI reporting, the UE 115-a may identify the corresponding antenna group 220 that the UE 115-a is to use for CSI reporting. In some cases, a trigger state may be configured with multiple CSI report configurations. In such cases, the UE 115-a may use the same antenna group 220 (e.g., SRS partial resource) for each CSI report in the trigger state. In other cases, as described herein, the RRC signaling may individually map the CSI report configurations to the respective antenna group 220 identifier. In such cases, the UE 115-a may use the antenna group resources corresponding to each CSI report configuration of the trigger state for CSI reporting.

According another technique, multiple SRS resources (e.g., antenna groups) may be indicated via the antenna group indication 210. In some cases, the UE 115-a may use multiple antenna groups 220 when multiple antenna groups 220 are indicated. When a trigger state includes multiple CSI report configurations, the UE 115-a may use an antenna group 220 of the indicated multiple groups for reference signal measurement and reporting. In some examples, as described herein, the antenna groups 220 may be mapped to indexes. Thus, a CSI reporting configuration may indicate multiple indices to indicate multiple antenna groups 220. In another case, the control signaling may map multiple groups to a respective index. Thus, a set of groups may be indicated via an index.

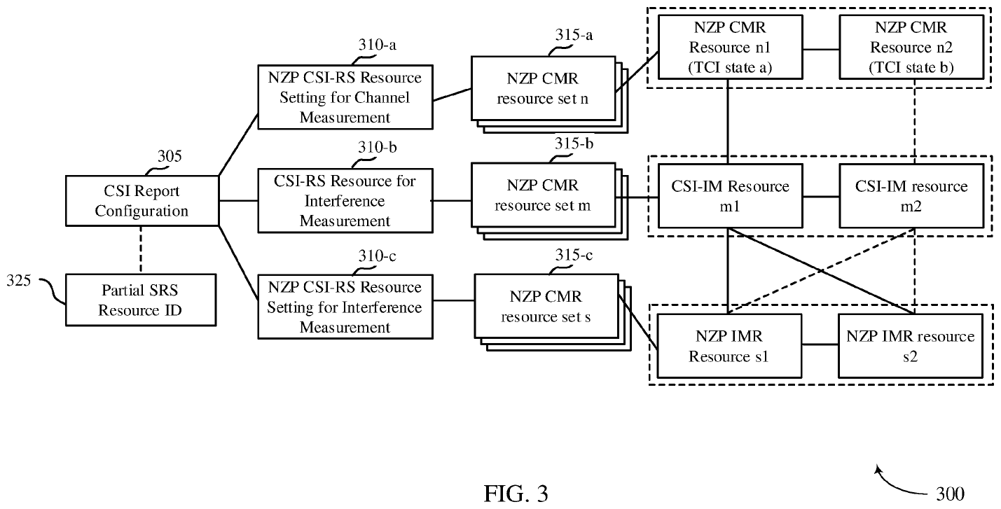

FIG. 3 illustrates an example of a resource configuration 300 that supports CSI-RS resources and reporting based on antenna grouping in accordance with aspects of the present disclosure. The resource configuration 300 may be used by a base station 105 and a UE 115, as described with respect to FIGS. 1 and 2. For example, the resource configuration 300 may be associated with a CSI reporting configuration 305 that is to be used for measurement and CSI reporting using one or more antenna groups (e.g., antenna groups 220 of FIG. 2). In some cases, the antenna groups may be associated with an SRS resource set used for sounding.

The resource configuration 300 may indicate a set of resource indications 310. Each resource indication 310 may specify resource set 315 to use for measurement and reporting. For example, the resource indication 310-a may specify resource set 315 that are to be used for NZP CSI-RS channel measurement. Further, resource indication 310-b may specify resource set 315-b that are to be use for CSI-RS interference measurement. Resource indication 310-c may specify resource set 315-c to be used for NZP CSI-RS interference measurement. In some cases, the resources for each operation or measurement may be associated. For example, the resource set 315-a and 315-b may have a resources wise association, and the resource set 315-b and 315-c may have a collective association. More particularly, the CMR resources may be associated with all of the NZP interference measurement resources collectively.

A CSI reporting configuration may indicate one NZP CSI-RS resource setting for channel measurement (e.g., resource indication 310-a) and zero, one, or two resource settings for interference measurement. If the reporting configuration indicates one setting for interference measurement, the resource may be either a zero-power CSI-IM setting (e.g., resource indication 310-b). If the reporting configuration indicates two settings for interference measurement, then the setting may correspond to a CSI-IM setting (e.g., resource indication 310-b) and an NZP CSI-RS setting (e.g., resource indication 310-c). For NZP CSI-RS interference measurement, any single port corresponding to the activated resources may be assumed as an interference layer, and as such, a UE 115 may aggregate the interference layers in the CSI calculations.

A set of CSI resources, such as the resources corresponding to the resource configuration 300 may be used for CSI measurement/reporting. Further, according to implementations described herein, the set of resources may be used with an indicated group of antennas for CSI measurement and reporting. Thus, a CSI configuration may indicate the set of resources and a partial SRS resource identifier 325 (e.g., a group of antennas) to use for CSI measurement and reporting. Further, a different group of antennas may be used for each CSI configuration report of a trigger state.

The partial SRS identifier 325 may correspond to either an antenna group that is not configured via SRS resource configuration or to an antenna group configured via the SRS resource configuration. For example, a set of antenna group indications may be configured by a UE 115 and the network (e.g., a base station 105) separate from SRS configuration. More particularly, the UE 115 and the base station 105 may identify which Rx antennas are grouped and the grouping configuration. Further, the UE 115 and the base station 105 may determine antenna group indexes that correspond to each group. As described herein, this antenna group index may be indicated via a CSI-RS resource configuration or may be mapped to a set of aperiodic-CSI trigger states. Thus, the antenna group indexes, which may not be configured via the SRS configuration, may correspond to the partial SRS resource identifier 325 as described herein. Additionally or alternatively, a set of SRS partial resource identifier 335 may be configured as part of the SRS configuration between the base station 105 and the UE 115. That is, during SRS configuration, the antenna groups are configured as corresponding to SRS partial resources. Thus, the SRS partial resource identifiers may be adopted as indications of antenna groups. As such, the base station may signal the partial SRS resource identifier 325 (e.g., via CSI-RS configuration or trigger state indication), which corresponds to an antenna group as configured during the SRS configuration.

In some cases, the SRS resource identifier 325 may correspond to multiple SRS partial resources (e.g., multiple antenna groups). Thus, control signaling may be used to map multiple groups to an index or SRS resource identifier. For example, antenna groups 0, 1, 2, and 3 may be configured at a UE. RRC and/or MAC-CE signaling may be used to map groups 0 and 1 to index 0, groups 0, 1, and 2 to index 1, groups 1 and 2 to index 2, etc. The base station may signal one or more of the indexes for a CSI report configuration or a trigger state.

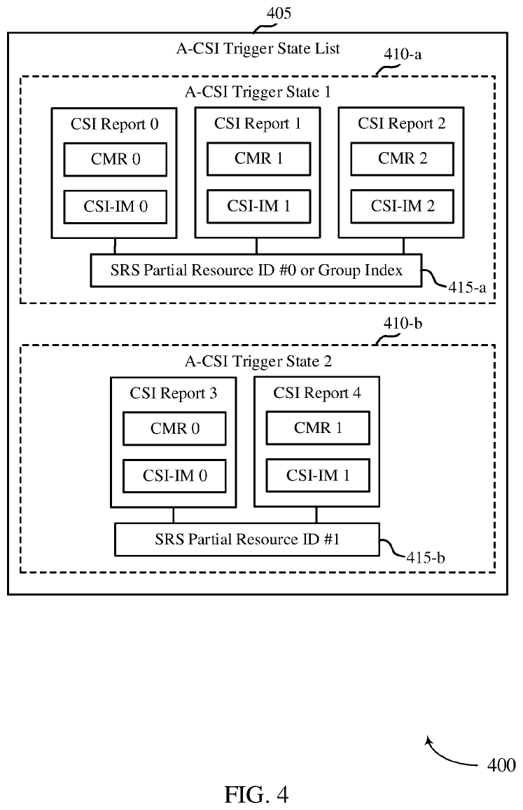

FIG. 4 illustrates an example of set of trigger states 400 that supports CSI-RS resources and reporting based on antenna grouping in accordance with aspects of the present disclosure. The set of trigger states 400 may be used by a base station 105 and a UE 115, as described with respect to FIGS. 1 and 2. For example, one or more of the set of trigger states 400 may be indicated by a base station 105 to a UE 115 for CSI measurement and reporting.

A base station 105 may use control signaling to configure the UE 115 with trigger states, including the set of trigger states 400, for example. Additional control signaling may be used to downselect the trigger states and indicate one or more trigger states to use to determining CSI measurement/reporting configurations. For example, RRC signaling may configure the UE 115 with the trigger states, MAC-CE signaling may be used to downselect the trigger states to a set of trigger states 400 via a trigger state list 405, and DCI signaling may indicate one or more trigger states 410 of the set of trigger states to use to determine configuration(s) for CSI measurement and reporting.

Further, as described herein, control signaling (e.g., RRC signaling) may be used to map SRS resources (e.g., antenna groups) to each trigger state. As illustrated, trigger state 410-a is mapped to SRS partial resource identifier 415-a, and trigger state 410-b is mapped to SRS partial resource identifier 415-b. As each trigger state 410 may include more than one CSI report configuration, each with designation of respective resources to use for CSI measurement and reporting, the antenna group corresponding to the SRS partial resource identifier 415 may be used for receiving the reference signal and measuring and reporting the reference signal using the respective resources for each CSI report configuration.

Accordingly, if a control signal (e.g., DCI) indicates that the UE is to use the trigger state 410-b, then the UE may receive the reference signal using the antenna group corresponding to SRS partial resource identifier 415-b. Additionally, the UE 115 may use the resources indicated by CSI Report 3 for measurement and reporting and use the resource indicated by CSI Report 4 for measurement and reporting. The UE 115 may also generate a report for each CSI report configuration, and the report may be based on receiving and measuring the reference signal received using the antenna group corresponding to SRS partial resource identifier 415-b.

As described herein, a set of antenna groups may be mapped to a trigger state. In some examples, the mapping may be based on the amount of CSI report configurations for a trigger state 410. For example, the base station 105 may map three groups of antennas to trigger state 410-a, since trigger state 410-a includes three CSI report configurations. Similarly, the base station 105 may map two groups of antennas to trigger state 410-b, since trigger state 410-b includes two CSI report configurations. In such cases, the UE may use one of the antenna groups for each CSI report configuration of a trigger state.

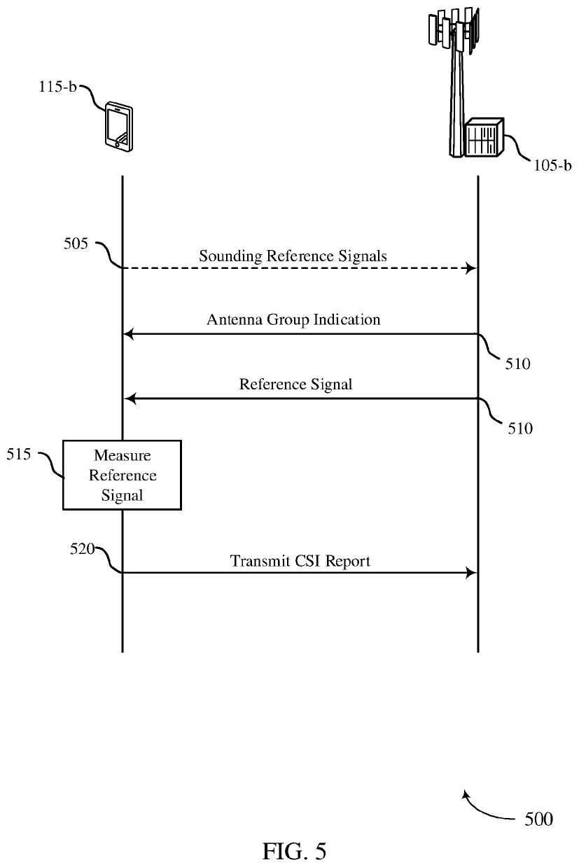

FIG. 5 illustrates an example of a process flow 500 that illustrates CSI-RS resources and reporting based on antenna grouping in accordance with aspects of the present disclosure. The process flow 500 includes a UE 115-b and a base station 105-b, which may be examples of the corresponding devices as described with respect to FIGS. 1 through 4.

At 505, the UE 115-b may transmit, to the base station 105-b, a set of sounding reference signals to the base station 105-b. Each sounding reference signal may be transmitted by one or more antennas of a respective group of antennas. The set of sounding reference signals may be transmitted in response to receiving a sounding request from the base station 105-b.

At 510, the UE 115-b may receive, from the base station 105-b, an indication of an antenna group that the UE 115-b is to use in measuring and reporting channel state information. The antenna group being one of a plurality of antenna groups configured at the UE. The antenna group may be one of the antenna groups that were used to transmit the sounding reference signals. In other cases, the antenna group may be otherwise configured at the UE 115-b. In some cases, the UE 115-b may transmit, to the base station 105-b, an indication that the UE 115-b is capable of supporting antenna groups, and the indication may be received in response to transmitting the capability indication. The indication may be transmitted with a CSI report configuration or via an indication of a trigger state. Thus, control signaling may be used to map one or more antenna groups to SRS resource identifiers, CSI report configurations, trigger states, or combinations thereof.

At 515, the base station 105-b may transmit one or more reference signals to the UE 115-b. The reference signals may be configured for CSI measurement and reporting. Thus, the reference signals may be examples of CSI-RSs.

At 515, the UE 115-b may measure the reference signal transmitted by the base station and received at the UE 115-b using one or more antennas of the antenna group in accordance with the indication. In some examples, the reference signals are received, measured, and reported, based on resources indicated by a CSI report configuration. The CSI report configuration may correspond to a trigger state. In some cases, the UE 115-b uses multiple CSI report configurations for a trigger state.

At 520, the UE 115-b may transmit, to the base station 105-a, a channel state information report that is based at least in part on the measuring of the reference signal using the one or more antennas of the antenna group.

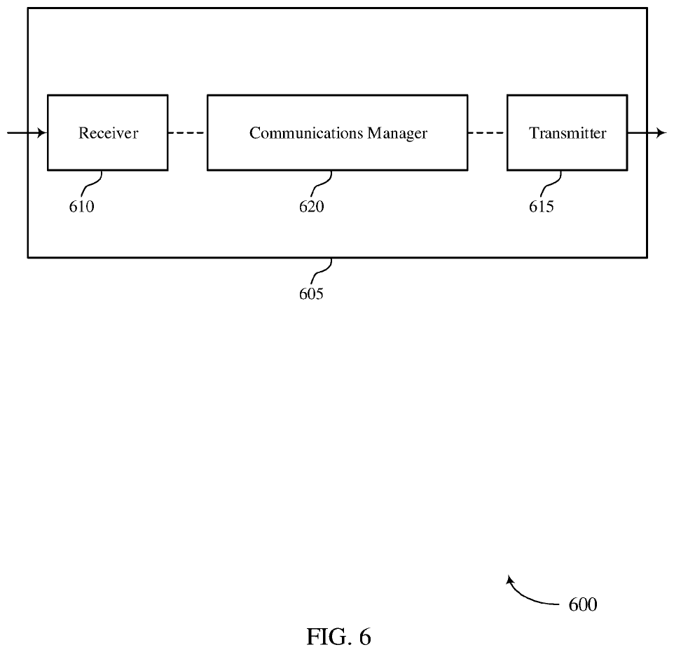

FIG. 6 shows a block diagram 600 of a device 605 that supports CSI-RS resources and reporting based on antenna grouping in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to CSI-RS resources and reporting based on antenna grouping). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to CSI-RS resources and reporting based on antenna grouping). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of CSI-RS resources and reporting based on antenna grouping as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving, from a base station, an indication of an antenna group that the UE is to use in measuring and reporting channel state information, the antenna group being one of a set of multiple antenna groups configured at the UE. The communications manager 620 may be configured as or otherwise support a means for measuring a reference signal transmitted by the base station and received at the UE using one or more antennas of the antenna group in accordance with the indication. The communications manager 620 may be configured as or otherwise support a means for transmitting, to the base station, a channel state information report that is based on the measuring of the reference signal using the one or more antennas of the antenna group.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for improving the framework for identifying channel characteristics for improved and more efficient communications. For example, by leveraging pre-configured antenna groups, the device 605 may efficiently identify channel characteristics corresponding to a group that may be used for subsequent communications. Further, the techniques may support reduced processing overhead and power consumption by using antenna groups for determining channel characteristics.

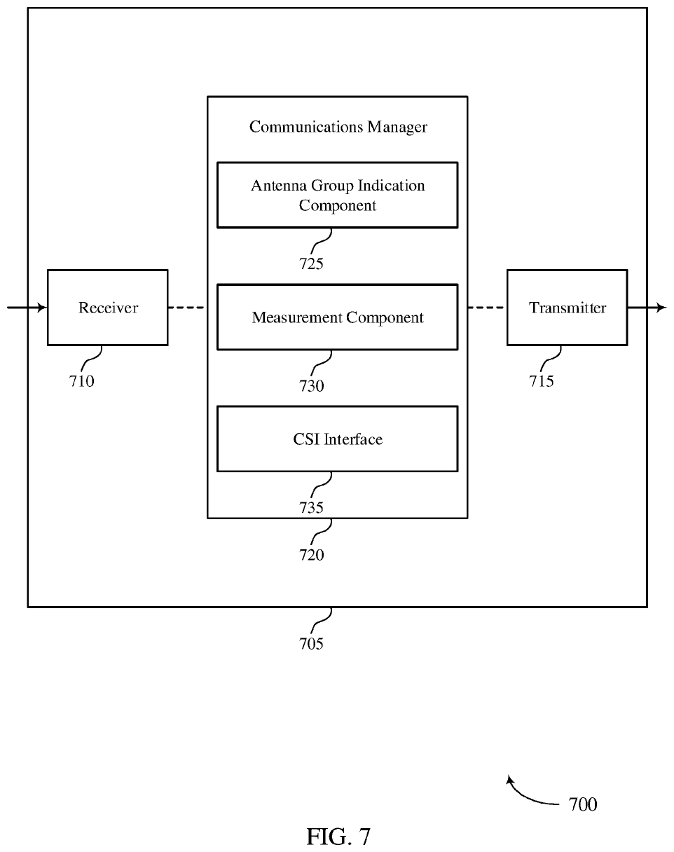

FIG. 7 shows a block diagram 700 of a device 705 that supports CSI-RS resources and reporting based on antenna grouping in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to CSI-RS resources and reporting based on antenna grouping). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to CSI-RS resources and reporting based on antenna grouping). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of CSI-RS resources and reporting based on antenna grouping as described herein. For example, the communications manager 720 may include an antenna group indication component 725, a measurement component 730, a CSI interface 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The antenna group indication component 725 may be configured as or otherwise support a means for receiving, from a base station, an indication of an antenna group that the UE is to use in measuring and reporting channel state information, the antenna group being one of a set of multiple antenna groups configured at the UE. The measurement component 730 may be configured as or otherwise support a means for measuring a reference signal transmitted by the base station and received at the UE using one or more antennas of the antenna group in accordance with the indication. The CSI interface 735 may be configured as or otherwise support a means for transmitting, to the base station, a channel state information report that is based on the measuring of the reference signal using the one or more antennas of the antenna group.

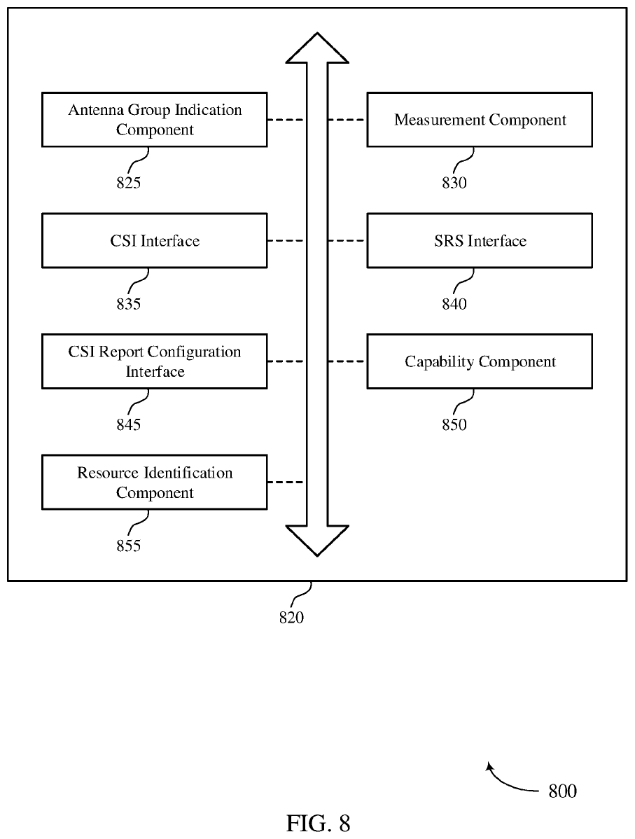

FIG. 8 shows a block diagram 800 of a communications manager 820 that supports CSI-RS resources and reporting based on antenna grouping in accordance with aspects of the present disclosure. The communications manager 820 may be an example of aspects of a communications manager 620, a communications manager 720, or both, as described herein. The communications manager 820, or various components thereof, may be an example of means for performing various aspects of CSI-RS resources and reporting based on antenna grouping as described herein. For example, the communications manager 820 may include an antenna group indication component 825, a measurement component 830, a CSI interface 835, an SRS interface 840, a CSI report configuration interface 845, a capability component 850, a resource identification component 855, or any combination thereof. Each of these components may communicate, directly or indirectly, with one another (e.g., via one or more buses).

The communications manager 820 may support wireless communications at a UE in accordance with examples as disclosed herein. The antenna group indication component 825 may be configured as or otherwise support a means for receiving, from a base station, an indication of an antenna group that the UE is to use in measuring and reporting channel state information, the antenna group being one of a set of multiple antenna groups configured at the UE. The measurement component 830 may be configured as or otherwise support a means for measuring a reference signal transmitted by the base station and received at the UE using one or more antennas of the antenna group in accordance with the indication. The CSI interface 835 may be configured as or otherwise support a means for transmitting, to the base station, a channel state information report that is based on the measuring of the reference signal using the one or more antennas of the antenna group.

In some examples, the SRS interface 840 may be configured as or otherwise support a means for transmitting, to the base station, a respective sounding reference signal using at least one antenna of each antenna group of the set of multiple antenna groups, where the indication is received based on transmitting the respective sounding reference signal for each antenna group.

In some examples, the measurement component 830 may be configured as or otherwise support a means for determining a precoding for the reference signal in accordance with a precoding that is used to transmit the respective sounding reference signal from the indicated antenna group.

In some examples, to support receiving the indication, the CSI report configuration interface 845 may be configured as or otherwise support a means for receiving, from the base station, a channel state information report configuration with the indication of the antenna group.

In some examples, the resource identification component 855 may be configured as or otherwise support a means for determining one or more reference signal resources to use for measuring the reference signal based on the channel state information report configuration. In some examples, the CSI interface 835 may be configured as or otherwise support a means for generating the channel state information report in accordance with the channel state information report configuration and that is based on the measuring of the reference signal using the one or more antennas and the one or more reference signal resources.

In some examples, to support receiving the indication, the CSI report configuration interface 845 may be configured as or otherwise support a means for receiving, from the base station an indication of a channel state information trigger state. In some examples, to support receiving the indication, the antenna group indication component 825 may be configured as or otherwise support a means for determining the antenna group based on a mapping of the antenna group to one or more channel state information report configurations for the indication of the channel state information trigger state.

In some examples, to support receiving the indication of the channel state information trigger state, the CSI report configuration interface 845 may be configured as or otherwise support a means for receiving a downlink control information message, a medium access control layer control element message, or a combination thereof.

In some examples, the CSI report configuration interface 845 may be configured as or otherwise support a means for receiving, from the base station, a first control message that maps a respective antenna group of the set of multiple antenna groups to each trigger state of a set of trigger states, where the indication is received based at least in part on receiving an indication of a trigger state of the set of trigger states.

In some examples, to support receiving the first control message, the CSI report configuration interface 845 may be configured as or otherwise support a means for receiving a radio resource control message, a medium access control layer control element message, or a combination thereof.

In some examples, the CSI report configuration interface 845 may be configured as or otherwise support a means for receiving, from the base station, a first control message that maps one or more antenna groups of the set of multiple antenna groups to a respective antenna group index of a set of antenna group indexes, where the indication of the antenna group is received based on receiving an indication of an antenna group index of the set of antenna group indexes.

In some examples, to support receiving the first control message, the CSI report configuration interface 845 may be configured as or otherwise support a means for receiving a radio resource control message, a medium access control layer control element message, or a combination thereof.

In some examples, to support receiving the indication, the CSI report configuration interface 845 may be configured as or otherwise support a means for receiving an indication of a trigger state of a set of trigger states and an indication of the antenna group index of the set of antenna group indexes, where the antenna group corresponding to the antenna group index is used for at least one channel state information report configuration corresponding to the trigger state.

In some examples, the capability component 850 may be configured as or otherwise support a means for transmitting, to the base station, an indication that the UE is capable of supporting the set of multiple antenna groups, where the indication of the antenna group is received based on transmitting the indication that the UE is capable of supporting the set of multiple antenna groups.

In some examples, each antenna group of the set of multiple antenna groups includes a same number of antennas or each antenna.

In some examples, a first antenna group of the set of multiple antenna groups includes a first quantity of antennas that is different from a second quantity of antennas of a second antenna group of the set of multiple antenna groups.

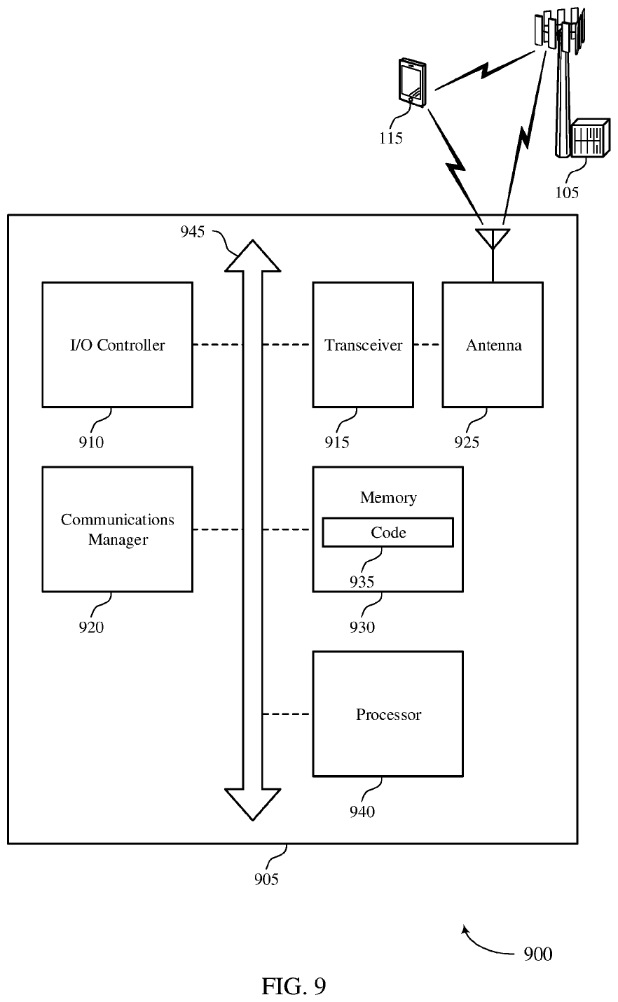

FIG. 9 shows a diagram of a system 900 including a device 905 that supports CSI-RS resources and reporting based on antenna grouping in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting CSI-RS resources and reporting based on antenna grouping). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a base station, an indication of an antenna group that the UE is to use in measuring and reporting channel state information, the antenna group being one of a set of multiple antenna groups configured at the UE. The communications manager 920 may be configured as or otherwise support a means for measuring a reference signal transmitted by the base station and received at the UE using one or more antennas of the antenna group in accordance with the indication. The communications manager 920 may be configured as or otherwise support a means for transmitting, to the base station, a channel state information report that is based on the measuring of the reference signal using the one or more antennas of the antenna group.

By including or configuring the communications manager 920 in accordance with examples as described herein, the device 905 may support techniques for improving the framework for identifying channel characteristics for improved and more efficient communications. For example, by leveraging pre-configured antenna groups, the device 905 may efficiently identify channel characteristics that may be used for subsequent communications. Further, the techniques may support reduced processing overhead and power consumption by using antenna groups for determining channel characteristics.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of CSI-RS resources and reporting based on antenna grouping as described herein, or the processor 940 and the memory 930 may be otherwise configured to perform or support such operations.

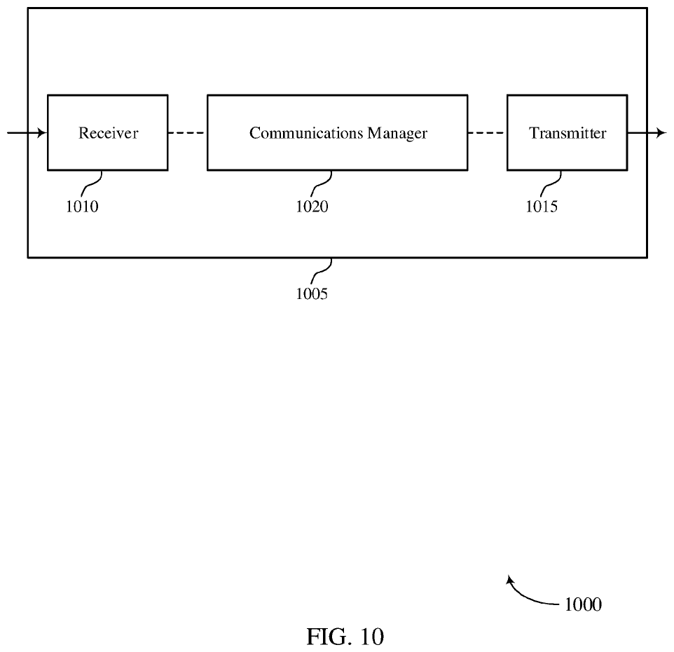

FIG. 10 shows a block diagram 1000 of a device 1005 that supports CSI-RS resources and reporting based on antenna grouping in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to CSI-RS resources and reporting based on antenna grouping). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to CSI-RS resources and reporting based on antenna grouping). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of CSI-RS resources and reporting based on antenna grouping as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for determining that a UE is configured with a set of multiple antenna groups. The communications manager 1020 may be configured as or otherwise support a means for transmitting, to the UE, an indication of an antenna group of the set of multiple antenna groups that the UE is to use in measuring and reporting channel state information to the base station. The communications manager 1020 may be configured as or otherwise support a means for transmitting a reference signal to the UE. The communications manager 1020 may be configured as or otherwise support a means for receiving, from the UE, a channel state information report that is based on measurements made by the UE of the reference signal using one or more antennas of the antenna group. The communications manager 1020 may be configured as or otherwise support a means for communicating, with the UE, based on the channel state information report.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for improving the framework for identifying channel characteristics for improved and more efficient communications. For example, by leveraging pre-configured antenna groups, the device 1005 may efficiently identify channel characteristics corresponding to a group that may be used for subsequent communications. Further, the techniques may support reduced processing overhead and power consumption by using antenna groups for determining channel characteristics.

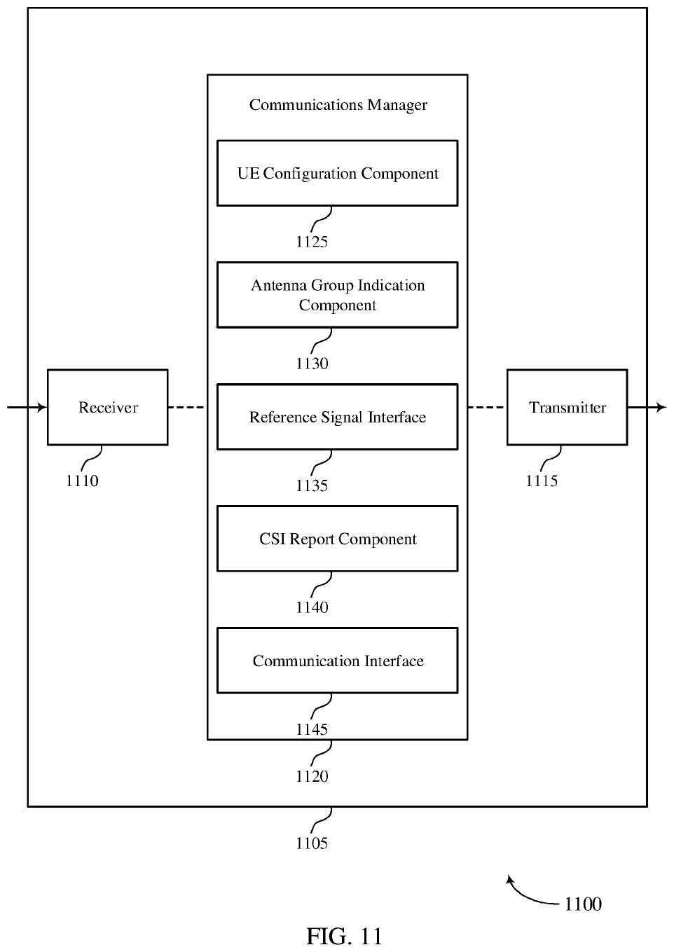

FIG. 11 shows a block diagram 1100 of a device 1105 that supports CSI-RS resources and reporting based on antenna grouping in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to CSI-RS resources and reporting based on antenna grouping). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to CSI-RS resources and reporting based on antenna grouping). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of CSI-RS resources and reporting based on antenna grouping as described herein. For example, the communications manager 1120 may include a UE configuration component 1125, an antenna group indication component 1130, a reference signal interface 1135, a CSI report component 1140, a communication interface 1145, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The UE configuration component 1125 may be configured as or otherwise support a means for determining that a UE is configured with a set of multiple antenna groups. The antenna group indication component 1130 may be configured as or otherwise support a means for transmitting, to the UE, an indication of an antenna group of the set of multiple antenna groups that the UE is to use in measuring and reporting channel state information to the base station. The reference signal interface 1135 may be configured as or otherwise support a means for transmitting a reference signal to the UE. The CSI report component 1140 may be configured as or otherwise support a means for receiving, from the UE, a channel state information report that is based on measurements made by the UE of the reference signal using one or more antennas of the antenna group. The communication interface 1145 may be configured as or otherwise support a means for communicating, with the UE, based on the channel state information report.

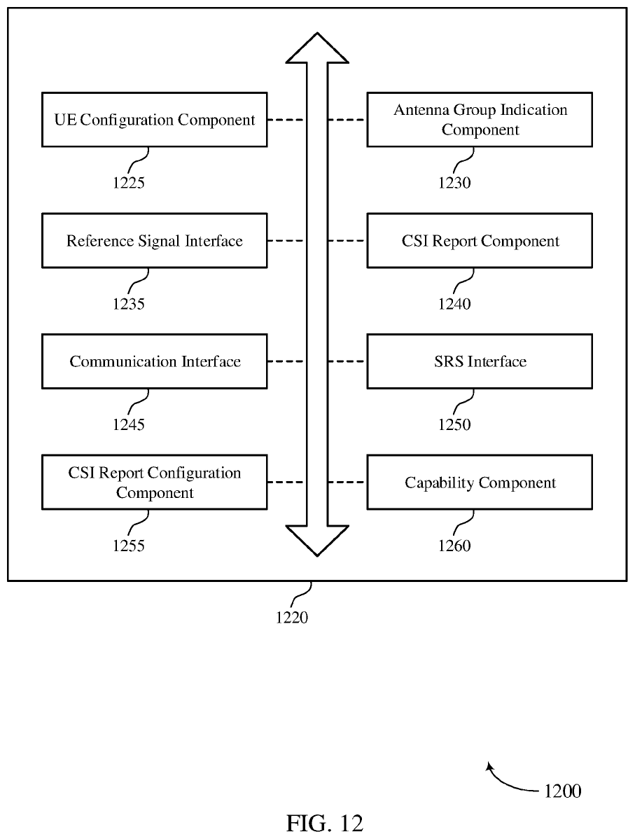

FIG. 12 shows a block diagram 1200 of a communications manager 1220 that supports CSI-RS resources and reporting based on antenna grouping in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of CSI-RS resources and reporting based on antenna grouping as described herein. For example, the communications manager 1220 may include a UE configuration component 1225, an antenna group indication component 1230, a reference signal interface 1235, a CSI report component 1240, a communication interface 1245, an SRS interface 1250, a CSI report configuration component 1255, a capability component 1260, or any combination thereof. Each of these components may communicate, directly or indirectly, with one another (e.g., via one or more buses).

The communications manager 1220 may support wireless communications at a base station in accordance with examples as disclosed herein. The UE configuration component 1225 may be configured as or otherwise support a means for determining that a UE is configured with a set of multiple antenna groups. The antenna group indication component 1230 may be configured as or otherwise support a means for transmitting, to the UE, an indication of an antenna group of the set of multiple antenna groups that the UE is to use in measuring and reporting channel state information to the base station. The reference signal interface 1235 may be configured as or otherwise support a means for transmitting a reference signal to the UE. The CSI report component 1240 may be configured as or otherwise support a means for receiving, from the UE, a channel state information report that is based on measurements made by the UE of the reference signal using one or more antennas of the antenna group. The communication interface 1245 may be configured as or otherwise support a means for communicating, with the UE, based on the channel state information report.

In some examples, the SRS interface 1250 may be configured as or otherwise support a means for receiving, from the UE, a respective sounding reference signal using at least one antenna of each antenna group of the set of multiple antenna groups, where the indication is transmitted based on receiving the respective sounding reference signal for each antenna group.

In some examples, to support transmitting the indication, the CSI report configuration component 1255 may be configured as or otherwise support a means for transmitting, to the UE, a channel state information report configuration with the indication of the antenna group.

In some examples, the CSI report configuration component 1255 may be configured as or otherwise support a means for determining one or more reference signal resources that the UE is to use for measuring the reference signal based on the channel state information report configuration, where the received channel state information report indicates the measurements corresponding to the one or more reference signal resources.

In some examples, to support transmitting the indication, the CSI report configuration component 1255 may be configured as or otherwise support a means for transmitting, to the UE, an indication of a channel state information trigger state, where the indication of the antenna group is transmitted based on the antenna group being mapped to the indicated channel state information trigger state.

In some examples, to support transmitting the indication of the channel state information trigger state, the CSI report configuration component 1255 may be configured as or otherwise support a means for transmitting a downlink control information message, a medium access control layer control element message, or a combination thereof.

In some examples, the CSI report configuration component 1255 may be configured as or otherwise support a means for transmitting, to the UE, a first control message that maps a respective antenna group of the set of multiple antenna groups to each trigger state of a set of trigger states, where the indication is transmitted based on transmitting an indication of a trigger state of the set of trigger states.

In some examples, to support transmitting the first control message, the CSI report configuration component 1255 may be configured as or otherwise support a means for transmitting a radio resource control message, a medium access control layer control element message, or a combination thereof.

In some examples, the CSI report configuration component 1255 may be configured as or otherwise support a means for transmitting, to the UE, a first control message that maps one or more antenna groups of the set of multiple antenna groups to a respective antenna group index of a set of antenna group indexes, where the indication of the antenna group is transmitted based on transmitting an indication of an antenna group index of the set of antenna group indexes.

In some examples, to support transmitting the first control message, the CSI report configuration component 1255 may be configured as or otherwise support a means for transmitting a radio resource control message, a medium access control layer control element message, or a combination thereof.

In some examples, to support transmitting the indication, the CSI report configuration component 1255 may be configured as or otherwise support a means for transmitting an indication of a trigger state of a set of trigger states and an indication of the antenna group index of the set of antenna group indexes, where the antenna group corresponding to the antenna group index is used for at least one channel state information report configuration corresponding to the trigger state.

In some examples, the capability component 1260 may be configured as or otherwise support a means for receiving, from the UE, an indication that the UE is capable of supporting the set of multiple antenna groups, where the indication of the antenna group is transmitted based on transmitting the indication that the UE is capable of supporting the set of multiple antenna groups.

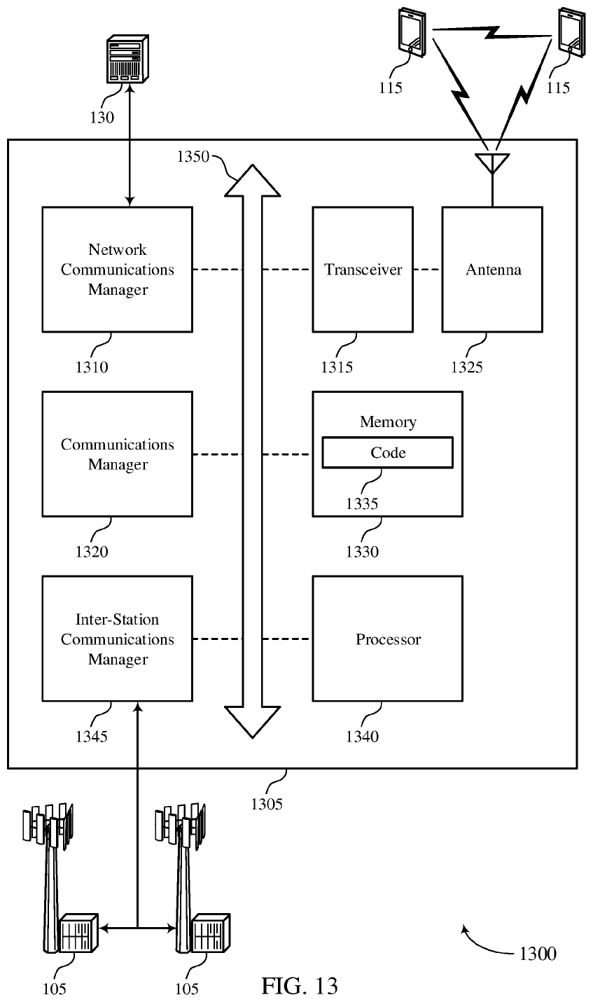

FIG. 13 shows a diagram of a system 1300 including a device 1305 that supports CSI-RS resources and reporting based on antenna grouping in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting CSI-RS resources and reporting based on antenna grouping). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for determining that a UE is configured with a set of multiple antenna groups. The communications manager 1320 may be configured as or otherwise support a means for transmitting, to the UE, an indication of an antenna group of the set of multiple antenna groups that the UE is to use in measuring and reporting channel state information to the base station. The communications manager 1320 may be configured as or otherwise support a means for transmitting a reference signal to the UE. The communications manager 1320 may be configured as or otherwise support a means for receiving, from the UE, a channel state information report that is based on measurements made by the UE of the reference signal using one or more antennas of the antenna group. The communications manager 1320 may be configured as or otherwise support a means for communicating, with the UE, based on the channel state information report.

By including or configuring the communications manager 1320 in accordance with examples as described herein, the device 1305 may support techniques for improving the framework for identifying channel characteristics for improved and more efficient communications. For example, by leveraging pre-configured antenna groups, the device 1305 may efficiently identify channel characteristics that may be used for subsequent communications. Further, the techniques may support reduced processing overhead and power consumption by using antenna groups for determining channel characteristics.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of CSI-RS resources and reporting based on antenna grouping as described herein, or the processor 1340 and the memory 1330 may be otherwise configured to perform or support such operations.

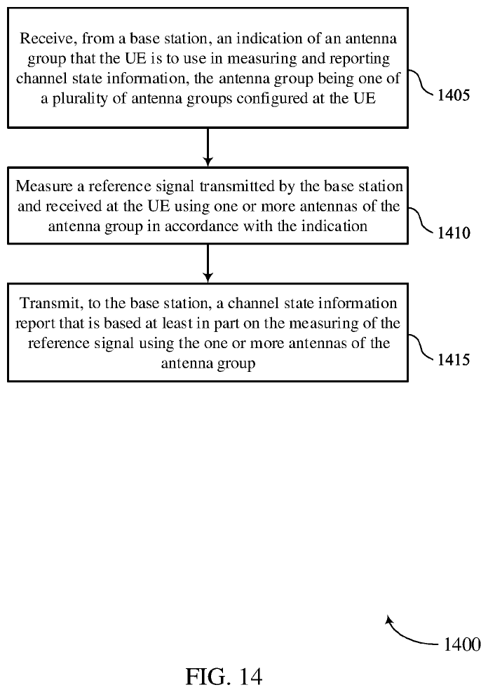

FIG. 14 shows a flowchart illustrating a method 1400 that supports CSI-RS resources and reporting based on antenna grouping in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, an indication of an antenna group that the UE is to use in measuring and reporting channel state information, the antenna group being one of a set of multiple antenna groups configured at the UE. The operations of 1405 may be performed in accordance with examples as disclosed herein. In some examples, aspects of the operations of 1405 may be performed by an antenna group indication component 825 as described with reference to FIG. 8.

At 1410, the method may include measuring a reference signal transmitted by the base station and received at the UE using one or more antennas of the antenna group in accordance with the indication. The operations of 1410 may be performed in accordance with examples as disclosed herein. In some examples, aspects of the operations of 1410 may be performed by a measurement component 830 as described with reference to FIG. 8.

At 1415, the method may include transmitting, to the base station, a channel state information report that is based on the measuring of the reference signal using the one or more antennas of the antenna group. The operations of 1415 may be performed in accordance with examples as disclosed herein. In some examples, aspects of the operations of 1415 may be performed by a CSI interface 835 as described with reference to FIG. 8.

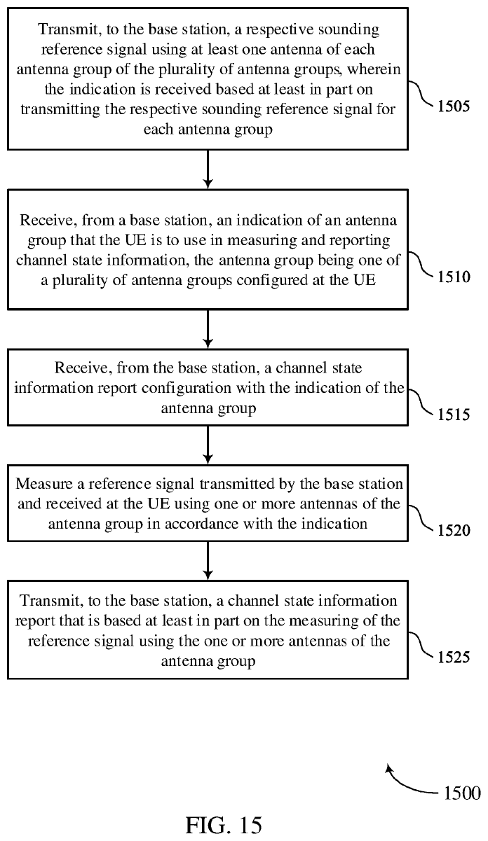

FIG. 15 shows a flowchart illustrating a method 1500 that supports CSI-RS resources and reporting based on antenna grouping in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include transmitting, to the base station, a respective sounding reference signal using at least one antenna of each antenna group of the set of multiple antenna groups, where the indication is received based on transmitting the respective sounding reference signal for each antenna group. The operations of 1505 may be performed in accordance with examples as disclosed herein. In some examples, aspects of the operations of 1505 may be performed by an SRS interface 840 as described with reference to FIG. 8.

At 1510, the method may include receiving, from a base station, an indication of an antenna group that the UE is to use in measuring and reporting channel state information, the antenna group being one of a set of multiple antenna groups configured at the UE. The operations of 1510 may be performed in accordance with examples as disclosed herein. In some examples, aspects of the operations of 1510 may be performed by an antenna group indication component 825 as described with reference to FIG. 8.

At 1515, the method may include receiving, from the base station, a channel state information report configuration with the indication of the antenna group. The operations of 1515 may be performed in accordance with examples as disclosed herein. In some examples, aspects of the operations of 1515 may be performed by a CSI report configuration interface 845 as described with reference to FIG. 8.

At 1520, the method may include measuring a reference signal transmitted by the base station and received at the UE using one or more antennas of the antenna group in accordance with the indication. The operations of 1520 may be performed in accordance with examples as disclosed herein. In some examples, aspects of the operations of 1520 may be performed by a measurement component 830 as described with reference to FIG. 8.

At 1525, the method may include transmitting, to the base station, a channel state information report that is based on the measuring of the reference signal using the one or more antennas of the antenna group. The operations of 1525 may be performed in accordance with examples as disclosed herein. In some examples, aspects of the operations of 1525 may be performed by a CSI interface 835 as described with reference to FIG. 8.

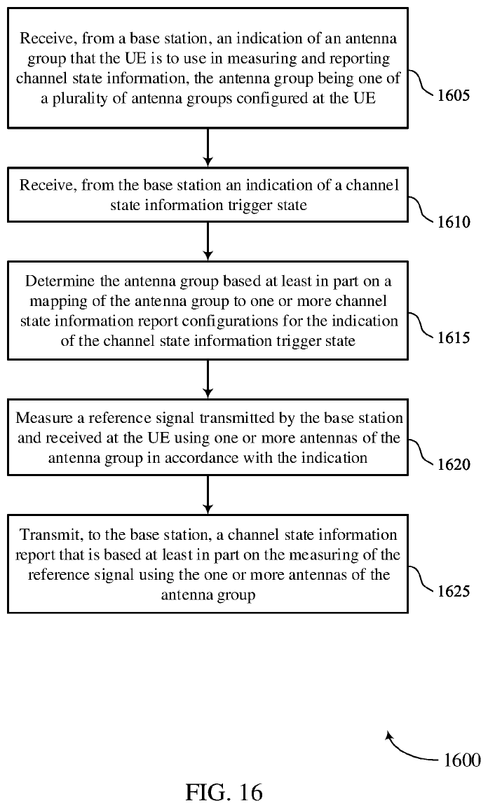

FIG. 16 shows a flowchart illustrating a method 1600 that supports CSI-RS resources and reporting based on antenna grouping in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1605, the method may include receiving, from a base station, an indication of an antenna group that the UE is to use in measuring and reporting channel state information, the antenna group being one of a set of multiple antenna groups configured at the UE. The operations of 1605 may be performed in accordance with examples as disclosed herein. In some examples, aspects of the operations of 1605 may be performed by an antenna group indication component 825 as described with reference to FIG. 8.

At 1610, the method may include receiving, from the base station an indication of a channel state information trigger state. The operations of 1610 may be performed in accordance with examples as disclosed herein. In some examples, aspects of the operations of 1610 may be performed by a CSI report configuration interface 845 as described with reference to FIG. 8.

At 1615, the method may include determining the antenna group based on a mapping of the antenna group to one or more channel state information report configurations for the indication of the channel state information trigger state. The operations of 1615 may be performed in accordance with examples as disclosed herein. In some examples, aspects of the operations of 1615 may be performed by an antenna group indication component 825 as described with reference to FIG. 8.

At 1620, the method may include measuring a reference signal transmitted by the base station and received at the UE using one or more antennas of the antenna group in accordance with the indication. The operations of 1620 may be performed in accordance with examples as disclosed herein. In some examples, aspects of the operations of 1620 may be performed by a measurement component 830 as described with reference to FIG. 8.

At 1625, the method may include transmitting, to the base station, a channel state information report that is based on the measuring of the reference signal using the one or more antennas of the antenna group. The operations of 1625 may be performed in accordance with examples as disclosed herein. In some examples, aspects of the operations of 1625 may be performed by a CSI interface 835 as described with reference to FIG. 8.

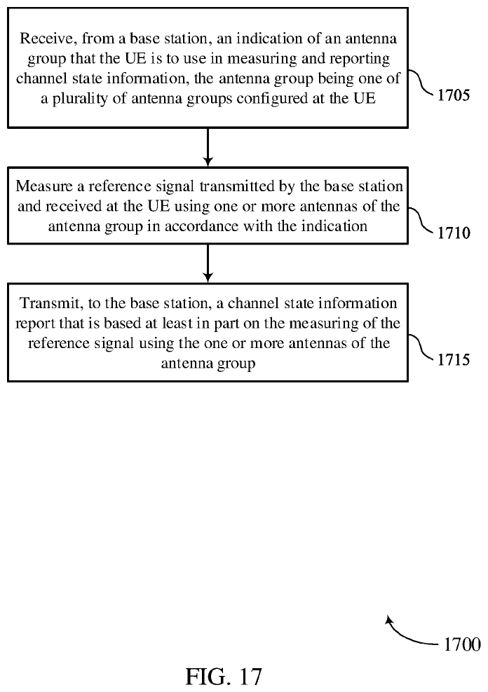

FIG. 17 shows a flowchart illustrating a method 1700 that supports CSI-RS resources and reporting based on antenna grouping in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, an indication of an antenna group that the UE is to use in measuring and reporting channel state information, the antenna group being one of a set of multiple antenna groups configured at the UE. The operations of 1705 may be performed in accordance with examples as disclosed herein. In some examples, aspects of the operations of 1705 may be performed by an antenna group indication component 825 as described with reference to FIG. 8.

At 1710, the method may include measuring a reference signal transmitted by the base station and received at the UE using one or more antennas of the antenna group in accordance with the indication. The operations of 1710 may be performed in accordance with examples as disclosed herein. In some examples, aspects of the operations of 1710 may be performed by a measurement component 830 as described with reference to FIG. 8.

At 1715, the method may include transmitting, to the base station, a channel state information report that is based on the measuring of the reference signal using the one or more antennas of the antenna group. The operations of 1715 may be performed in accordance with examples as disclosed herein. In some examples, aspects of the operations of 1715 may be performed by a CSI interface 835 as described with reference to FIG. 8.

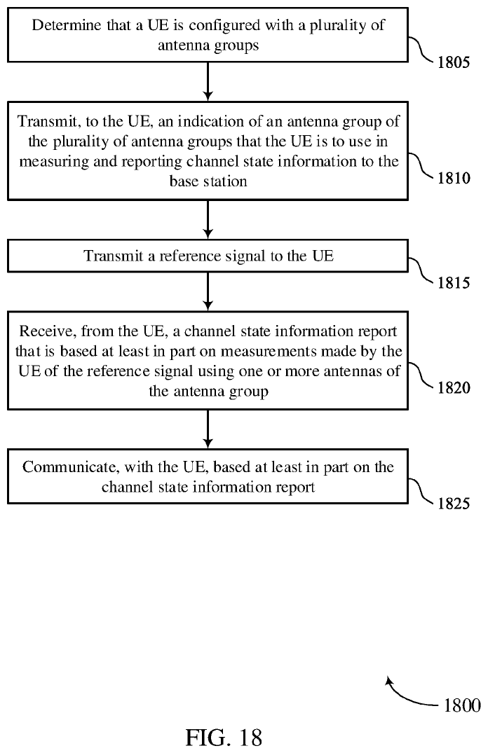

FIG. 18 shows a flowchart illustrating a method 1800 that supports CSI-RS resources and reporting based on antenna grouping in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1805, the method may include determining that a UE is configured with a set of multiple antenna groups. The operations of 1805 may be performed in accordance with examples as disclosed herein. In some examples, aspects of the operations of 1805 may be performed by a UE configuration component 1225 as described with reference to FIG. 12.

At 1810, the method may include transmitting, to the UE, an indication of an antenna group of the set of multiple antenna groups that the UE is to use in measuring and reporting channel state information to the base station. The operations of 1810 may be performed in accordance with examples as disclosed herein. In some examples, aspects of the operations of 1810 may be performed by an antenna group indication component 1230 as described with reference to FIG. 12.

At 1815, the method may include transmitting a reference signal to the UE. The operations of 1815 may be performed in accordance with examples as disclosed herein. In some examples, aspects of the operations of 1815 may be performed by a reference signal interface 1235 as described with reference to FIG. 12.

At 1820, the method may include receiving, from the UE, a channel state information report that is based on measurements made by the UE of the reference signal using one or more antennas of the antenna group. The operations of 1820 may be performed in accordance with examples as disclosed herein. In some examples, aspects of the operations of 1820 may be performed by a CSI report component 1240 as described with reference to FIG. 12.

At 1825, the method may include communicating, with the UE, based on the channel state information report. The operations of 1825 may be performed in accordance with examples as disclosed herein. In some examples, aspects of the operations of 1825 may be performed by a communication interface 1245 as described with reference to FIG. 12.

The following provides an overview of aspects of the present disclosure: Aspect 1: A method for wireless communications at a UE, comprising: receiving, from a base station, an indication of an antenna group that the UE is to use in measuring and reporting channel state information, the antenna group being one of a plurality of antenna groups configured at the UE; measuring a reference signal transmitted by the base station and received at the UE using one or more antennas of the antenna group in accordance with the indication; and transmitting, to the base station, a channel state information report that is based at least in part on the measuring of the reference signal using the one or more antennas of the antenna group.

Aspect 2: The method of aspect 1, further comprising: transmitting, to the base station, a respective sounding reference signal using at least one antenna of each antenna group of the plurality of antenna groups, wherein the indication is received based at least in part on transmitting the respective sounding reference signal for each antenna group.

Aspect 3: The method of aspect 2, further comprising: determining a precoding for the reference signal in accordance with a precoding that is used to transmit the respective sounding reference signal from the indicated antenna group.

Aspect 4: The method of any of aspects 1 through 3, wherein receiving the indication comprises: receiving, from the base station, a channel state information report configuration with the indication of the antenna group.

Aspect 5: The method of aspect 4, further comprising: determining one or more reference signal resources to use for measuring the reference signal based at least in part on the channel state information report configuration; and generating the channel state information report in accordance with the channel state information report configuration and that is based at least in part on the measuring of the reference signal using the one or more antennas and the one or more reference signal resources.

Aspect 6: The method of any of aspects 1 through 5, wherein receiving the indication comprises: receiving, from the base station an indication of a channel state information trigger state; and determining the antenna group based at least in part on a mapping of the antenna group to one or more channel state information report configurations for the indication of the channel state information trigger state.

Aspect 7: The method of aspect 6, wherein receiving the indication of the channel state information trigger state comprises: receiving a downlink control information message, a medium access control layer control element message, or a combination thereof.

Aspect 8: The method of any of aspects 1 through 7, further comprising: receiving, from the base station, a first control message that maps a respective antenna group of the plurality of antenna groups to each trigger state of a set of trigger states, wherein the indication is received based at least in part receiving an indication of a trigger state of the set of trigger states.

Aspect 9: The method of aspect 8, wherein receiving the first control message comprises: receiving a radio resource control message, a medium access control layer control element message, or a combination thereof.

Aspect 10: The method of any of aspects 1 through 9, further comprising: receiving, from the base station, a first control message that maps one or more antenna groups of the plurality of antenna groups to a respective antenna group index of a set of antenna group indexes, wherein the indication of the antenna group is received based at least in part on receiving an indication of an antenna group index of the set of antenna group indexes.

Aspect 11: The method of aspect 10, wherein receiving the first control message comprises: receiving a radio resource control message, a medium access control layer control element message, or a combination thereof.

Aspect 12: The method of any of aspects 10 through 11, wherein receiving the indication comprises: receiving an indication of a trigger state of a set of trigger states and an indication of the antenna group index of the set of antenna group indexes, wherein the antenna group corresponding to the antenna group index is used for at least one channel state information report configuration corresponding to the trigger state.

Aspect 13: The method of any of aspects 1 through 12, further comprising: transmitting, to the base station, an indication that the UE is capable of supporting the plurality of antenna groups, wherein the indication of the antenna group is received based at least in part on transmitting the indication that the UE is capable of supporting the plurality of antenna groups.

Aspect 14: The method of any of aspects 1 through 13, wherein each antenna group of the plurality of antenna groups includes a same number of antennas or each antenna.

Aspect 15: The method of any of aspects 1 through 14, wherein a first antenna group of the plurality of antenna groups includes a first quantity of antennas that is different from a second quantity of antennas of a second antenna group of the plurality of antenna groups.

Aspect 16: A method for wireless communications at a base station, comprising: determining that a UE is configured with a plurality of antenna groups; transmitting, to the UE, an indication of an antenna group of the plurality of antenna groups that the UE is to use in measuring and reporting channel state information to the base station; transmitting a reference signal to the UE; receiving, from the UE, a channel state information report that is based at least in part on measurements made by the UE of the reference signal using one or more antennas of the antenna group; and communicating, with the UE, based at least in part on the channel state information report.

Aspect 17: The method of aspect 16, further comprising: receiving, from the UE, a respective sounding reference signal using at least one antenna of each antenna group of the plurality of antenna groups, wherein the indication is transmitted based at least in part on receiving the respective sounding reference signal for each antenna group.

Aspect 18: The method of any of aspects 16 through 17, wherein transmitting the indication comprises: transmitting, to the UE, a channel state information report configuration with the indication of the antenna group.

Aspect 19: The method of aspect 18, further comprising: determining one or more reference signal resources that the UE is to use for measuring the reference signal based at least in part on the channel state information report configuration, wherein the received channel state information report indicates the measurements corresponding to the one or more reference signal resources.

Aspect 20: The method of any of aspects 16 through 19, wherein transmitting the indication comprises: transmitting, to the UE, an indication of a channel state information trigger state, wherein the indication of the antenna group is transmitted based at least in part on the antenna group being mapped to the indicated channel state information trigger state.

Aspect 21: The method of aspect 20, wherein transmitting the indication of the channel state information trigger state comprises: transmitting a downlink control information message, a medium access control layer control element message, or a combination thereof.

Aspect 22: The method of any of aspects 16 through 21, further comprising: transmitting, to the UE, a first control message that maps a respective antenna group of the plurality of antenna groups to each trigger state of a set of trigger states, wherein the indication is transmitted based at least in part on transmitting an indication of a trigger state of the set of trigger states.

Aspect 23: The method of aspect 22, wherein transmitting the first control message comprises: transmitting a radio resource control message, a medium access control layer control element message, or a combination thereof.

Aspect 24: The method of any of aspects 16 through 23, further comprising: transmitting, to the UE, a first control message that maps one or more antenna groups of the plurality of antenna groups to a respective antenna group index of a set of antenna group indexes, wherein the indication of the antenna group is transmitted based at least in part on transmitting an indication of an antenna group index of the set of antenna group indexes.

Aspect 25: The method of aspect 24, wherein transmitting the first control message comprises: transmitting a radio resource control message, a medium access control layer control element message, or a combination thereof.

Aspect 26: The method of any of aspects 24 through 25, wherein transmitting the indication comprises: transmitting an indication of a trigger state of a set of trigger states and an indication of the antenna group index of the set of antenna group indexes, wherein the antenna group corresponding to the antenna group index is used for at least one channel state information report configuration corresponding to the trigger state.

Aspect 27: The method of any of aspects 16 through 26, further comprising: receiving, from the UE, an indication that the UE is capable of supporting the plurality of antenna groups, wherein the indication of the antenna group is transmitted based at least in part on transmitting the indication that the UE is capable of supporting the plurality of antenna groups.

Aspect 28: An apparatus for wireless communications at a UE, comprising a processor; memory coupled with the processor; and instructions stored in the memory and executable by the processor to cause the apparatus to perform a method of any of aspects 1 through 15.

Aspect 29: An apparatus for wireless communications at a UE, comprising at least one means for performing a method of any of aspects 1 through 15.

Aspect 30: A non-transitory computer-readable medium storing code for wireless communications at a UE, the code comprising instructions executable by a processor to perform a method of any of aspects 1 through 15.

Aspect 31: An apparatus for wireless communications at a base station, comprising a processor; memory coupled with the processor; and instructions stored in the memory and executable by the processor to cause the apparatus to perform a method of any of aspects 16 through 27.

Aspect 32: An apparatus for wireless communications at a base station, comprising at least one means for performing a method of any of aspects 16 through 27.

Aspect 33: A non-transitory computer-readable medium storing code for wireless communications at a base station, the code comprising instructions executable by a processor to perform a method of any of aspects 16 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, an indication of an antenna group that the UE is to use in measuring and reporting channel state information, the antenna group being one of a plurality of antenna groups configured at the UE;
measuring a reference signal transmitted by the base station and received at the UE using one or more antennas of the antenna group in accordance with the indication; and
transmitting, to the base station, a channel state information report that is based at least in part on the measuring of the reference signal using the one or more antennas of the antenna group.

2. The method of claim 1, further comprising:
transmitting, to the base station, a respective sounding reference signal using at least one antenna of each antenna group of the plurality of antenna groups, wherein the indication is received based at least in part on transmitting the respective sounding reference signal for each antenna group.

3. The method of claim 2, further comprising:
determining a precoding for the reference signal in accordance with a precoding that is used to transmit the respective sounding reference signal from the indicated antenna group.

4. The method of claim 1, wherein receiving the indication comprises:
receiving, from the base station, a channel state information report configuration with the indication of the antenna group.

5. The method of claim 4, further comprising:
determining one or more reference signal resources to use for measuring the reference signal based at least in part on the channel state information report configuration; and
generating the channel state information report in accordance with the channel state information report configuration and that is based at least in part on the measuring of the reference signal using the one or more antennas and the one or more reference signal resources.

6. The method of claim 1, wherein receiving the indication comprises:
receiving, from the base station an indication of a channel state information trigger state; and
determining the antenna group based at least in part on a mapping of the antenna group to one or more channel state information report configurations for the indication of the channel state information trigger state.

7. The method of claim 6, wherein receiving the indication of the channel state information trigger state comprises:
receiving a downlink control information message, a medium access control layer control element message, or a combination thereof.

8. The method of claim 1, further comprising:
receiving, from the base station, a first control message that maps a respective antenna group of the plurality of antenna groups to each trigger state of a set of trigger states, wherein the indication is received based at least in part on receiving an indication of a trigger state of the set of trigger states.

9. The method of claim 8, wherein receiving the first control message comprises:
receiving a radio resource control message, a medium access control layer control element message, or a combination thereof.

10. The method of claim 1, further comprising:
receiving, from the base station, a first control message that maps one or more antenna groups of the plurality of antenna groups to a respective antenna group index of a set of antenna group indexes, wherein the indication of the antenna group is received based at least in part on receiving an indication of an antenna group index of the set of antenna group indexes.

11. The method of claim 10, wherein receiving the first control message comprises:
receiving a radio resource control message, a medium access control layer control element message, or a combination thereof.

12. The method of claim 10, wherein receiving the indication comprises:
receiving an indication of a trigger state of a set of trigger states and an indication of the antenna group index of the set of antenna group indexes, wherein the antenna group corresponding to the antenna group index is used for at least one channel state information report configuration corresponding to the trigger state.

13. The method of claim 1, further comprising:
transmitting, to the base station, an indication that the UE is capable of supporting the plurality of antenna groups, wherein the indication of the antenna group is received based at least in part on transmitting the indication that the UE is capable of supporting the plurality of antenna groups.

14. The method of claim 1, wherein each antenna group of the plurality of antenna groups includes a same number of antennas or each antenna.

15. The method of claim 1, wherein a first antenna group of the plurality of antenna groups includes a first quantity of antennas that is different from a second quantity of antennas of a second antenna group of the plurality of antenna groups.

16. A method for wireless communications at a base station, comprising:
determining that a user equipment (UE) is configured with a plurality of antenna groups;
transmitting, to the UE, an indication of an antenna group of the plurality of antenna groups that the UE is to use in measuring and reporting channel state information to the base station;
transmitting a reference signal to the UE;
receiving, from the UE, a channel state information report that is based at least in part on measurements made by the UE of the reference signal using one or more antennas of the antenna group; and
communicating, with the UE, based at least in part on the channel state information report.

17. The method of claim 16, further comprising:
receiving, from the UE, a respective sounding reference signal using at least one antenna of each antenna group of the plurality of antenna groups, wherein the indication is transmitted based at least in part on receiving the respective sounding reference signal for each antenna group.

18. The method of claim 16, wherein transmitting the indication comprises:
transmitting, to the UE, a channel state information report configuration with the indication of the antenna group.

19. The method of claim 18, further comprising:
determining one or more reference signal resources that the UE is to use for measuring the reference signal based at least in part on the channel state information report configuration, wherein the received channel state information report indicates the measurements corresponding to the one or more reference signal resources.

20. The method of claim 16, wherein transmitting the indication comprises:
transmitting, to the UE, an indication of a channel state information trigger state, wherein the indication of the antenna group is transmitted based at least in part on the antenna group being mapped to the indicated channel state information trigger state.

21. The method of claim 20, wherein transmitting the indication of the channel state information trigger state comprises:
transmitting a downlink control information message, a medium access control layer control element message, or a combination thereof.

22. The method of claim 16, further comprising:
transmitting, to the UE, a first control message that maps a respective antenna group of the plurality of antenna groups to each trigger state of a set of trigger states, wherein the indication is transmitted based at least in part on transmitting an indication of a trigger state of the set of trigger states.

23. The method of claim 22, wherein transmitting the first control message comprises:
transmitting a radio resource control message, a medium access control layer control element message, or a combination thereof.

24. The method of claim 16, further comprising:
transmitting, to the UE, a first control message that maps one or more antenna groups of the plurality of antenna groups to a respective antenna group index of a set of antenna group indexes, wherein the indication of the antenna group is transmitted based at least in part on transmitting an indication of an antenna group index of the set of antenna group indexes.

25. A user equipment (UE), comprising:
a processor;
memory coupled with the processor; and
instructions stored in the memory and executable by the processor to cause the apparatus to:
receive, from a base station, an indication of an antenna group that the UE is to use in measuring and reporting channel state information, the antenna group being one of a plurality of antenna groups configured at the UE;
measure a reference signal transmitted by the base station and received at the UE using one or more antennas of the antenna group in accordance with the indication; and
transmit, to the base station, a channel state information report that is based at least in part on the measuring of the reference signal using the one or more antennas of the antenna group.

26. A base station, comprising:
a processor;
memory coupled with the processor; and
instructions stored in the memory and executable by the processor to cause the apparatus to:
determine that a user equipment (UE) is configured with a plurality of antenna groups;
transmit, to the UE, an indication of an antenna group of the plurality of antenna groups that the UE is to use in measuring and reporting channel state information to the base station;
transmit a reference signal to the UE;
receive, from the UE, a channel state information report that is based at least in part on measurements made by the UE of the reference signal using one or more antennas of the antenna group; and
communicate, with the UE, based at least in part on the channel state information report.

27. A user equipment (UE), comprising:
means for receiving, from a base station, an indication of an antenna group that the UE is to use in measuring and reporting channel state information, the antenna group being one of a plurality of antenna groups configured at the UE;
means for measuring a reference signal transmitted by the base station and received at the UE using one or more antennas of the antenna group in accordance with the indication; and
means for transmitting, to the base station, a channel state information report that is based at least in part on the measuring of the reference signal using the one or more antennas of the antenna group.

28. A base station, comprising:
means for determining that a user equipment (UE) is configured with a plurality of antenna groups;
means for transmitting, to the UE, an indication of an antenna group of the plurality of antenna groups that the UE is to use in measuring and reporting channel state information to the base station;
means for transmitting a reference signal to the UE;
means for receiving, from the UE, a channel state information report that is based at least in part on measurements made by the UE of the reference signal using one or more antennas of the antenna group; and
means for communicating, with the UE, based at least in part on the channel state information report.

29. A non-transitory computer-readable medium storing code for wireless communications at a user equipment (UE), the code comprising instructions executable by a processor to:
receive, from a base station, an indication of an antenna group that the UE is to use in measuring and reporting channel state information, the antenna group being one of a plurality of antenna groups configured at the UE;
measure a reference signal transmitted by the base station and received at the UE using one or more antennas of the antenna group in accordance with the indication; and
transmit, to the base station, a channel state information report that is based at least in part on the measuring of the reference signal using the one or more antennas of the antenna group.

30. A non-transitory computer-readable medium storing code for wireless communications at a base station, the code comprising instructions executable by a processor to:
determine that a user equipment (UE) is configured with a plurality of antenna groups;
transmit, to the UE, an indication of an antenna group of the plurality of antenna groups that the UE is to use in measuring and reporting channel state information to the base station;
transmit a reference signal to the UE;
receive, from the UE, a channel state information report that is based at least in part on measurements made by the UE of the reference signal using one or more antennas of the antenna group; and
communicate, with the UE, based at least in part on the channel state information report.
